(19) United States
(12) Patent Application Publication
(10) Pub. No.: US 2012/0275046 A1
(43) Pub. Date: Nov. 1, 2012

(54) SPLITTING A DATA STREAM BETWEEN TWO STORAGE MEDIA IN A HYBRID DISK DRIVE

(75) Inventor: Richard M. EHRLICH, Saratoga, CA (US)

(73) Assignee: Toshiba America Information Systems, Inc., Irvine, CA (US)

(21) Appl. No.: 13/095,578

(22) Filed: Apr. 27, 2011

(51) Int. Cl. G11B 5/02; G11B 5/86

(52) U.S. Cl. 360/15; 360/55; G9B/5.026; G9B/5.308

(57) ABSTRACT

A hybrid disk drive transfers a data stream to or from a host at an increased data transfer rate by time-multiplexing the data-carrying capacity of the system bus connecting the host and the disk drive. A portion of the data stream is stored on a non-volatile solid state memory device in the disk drive and a portion is written to a magnetic storage disk. The portion of the data stream written to the storage disk may be written on data tracks that are separated by empty data tracks corresponding to the data stored in the non-volatile solid state memory device.

### BACKGROUND OF THE INVENTION

1. Field of the Invention

Embodiments of the present invention relate generally to disk drives and, more particularly, to splitting a data stream between two storage media in a hybrid disk drive.

2. Description of the Related Art

In general, the processing speed of computer central processing units (CPUs) has increased far more quickly than the data transfer rate for computer hard disk drives (HDDs). This speed gap between the CPU and the HDD contributes to application delay, particularly when the storage and/or retrieval of large data streams is involved. For example, when placing a laptop computer into “hibernate” mode to save battery power, a large block of data, i.e., the hibernate image file, needs to be saved to the HDD before the HDD can power down completely. Because the hibernate image file can be on the order of one gigabyte in size or larger, and because the maximum data transfer rate to a 2.5 inch laptop HDD is on the order of about 150 megabytes/second, storing and retrieving the hibernate image file can require several seconds delay, which can be distracting and inconvenient for the end-user. Such delays are also common when any sizable data stream is transferred between an HDD and a host computer. Consequently, systems and methods that increase the data transfer rate between the host computer and the HDD of the computer are generally desirable.

### SUMMARY OF THE INVENTION

One or more embodiments of the present invention provide systems and methods for transferring a data stream between a host computer and a hybrid disk drive at an increased data transfer rate by time-multiplexing the data transfer capacity of the system bus between the storage disk and the flash memory device of the hybrid disk drive.

A method of storing a quantity of data in a hybrid data storage apparatus, according to an embodiment of the present invention, includes the steps of receiving data over a bus that connects the hybrid data storage apparatus to a host device, and alternately buffering the received data between first and second buffers, the first buffer being configured to buffer data for a magnetic storage device in the hybrid data storage apparatus and the second buffer being configured to buffer data for a flash memory device in the hybrid data storage apparatus.

A method of storing data for a file in a magnetic storage medium with concentric data tracks and a non-volatile solid state storage medium, according to an embodiment of the present invention, includes the steps of storing a first portion of the data in a first data track of the magnetic storage medium, storing a second portion of the data in the non-volatile solid state storage medium, and storing a third portion of the data in a second data track of the magnetic storage medium that is not adjacent to the first data track of the magnetic storage medium. One or more data tracks of the magnetic storage medium between the first data track and the second data track do not contain any portion of the data.

A hybrid data storage apparatus, according to an embodiment of the invention, includes a magnetic storage medium with concentric data tracks in which data for a file are stored, wherein each of the data tracks that contain data for the file is adjacent to data tracks that do not contain data for the file, and a non-volatile solid state storage medium that stores remaining data for the file.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an exemplary embodiment of a disk drive.

FIG. 2 illustrates a schematic view of a storage disk with data organized in a typical manner after servo wedges have been written on storage disk.

FIG. 3 illustrates a partial block diagram of a computing device with a disk drive disposed therein, according to an embodiment of the invention.

FIG. 4 is a flowchart of method steps for writing a data stream alternately to a flash memory device and to a storage disk, according to one embodiment of the present invention.

FIG. 5 is a flowchart of method steps for writing a data stream alternately to a flash memory device and to a storage disk, according to another embodiment of the present invention.

FIG. 6 illustrates a partial schematic diagram of a storage disk with empty data storage tracks alternated with completely written data tracks, according to an embodiment of the invention.

FIG. 7 is a flowchart of method steps for writing a data stream alternately to a flash memory device and to a magnetic storage disk, on which empty data storage tracks are alternated with completely written data tracks, according to one embodiment of the present invention.

FIG. 8 is a time line diagram illustrating transfer of data to a flash memory device and a storage disk when a flash buffer is too small to allow data to be continuously written to the flash memory device at the full speed of a system bus, according to embodiments of the invention.

FIG. 9 is a flowchart of method steps for storing a quantity of data in a hybrid data storage apparatus that includes a magnetic storage device and a flash memory device, according to one embodiment of the present invention.

FIG. 10 is a flowchart of method steps for storing data for a file in a magnetic storage medium with concentric data tracks and a non-volatile solid state storage medium, according to one embodiment of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

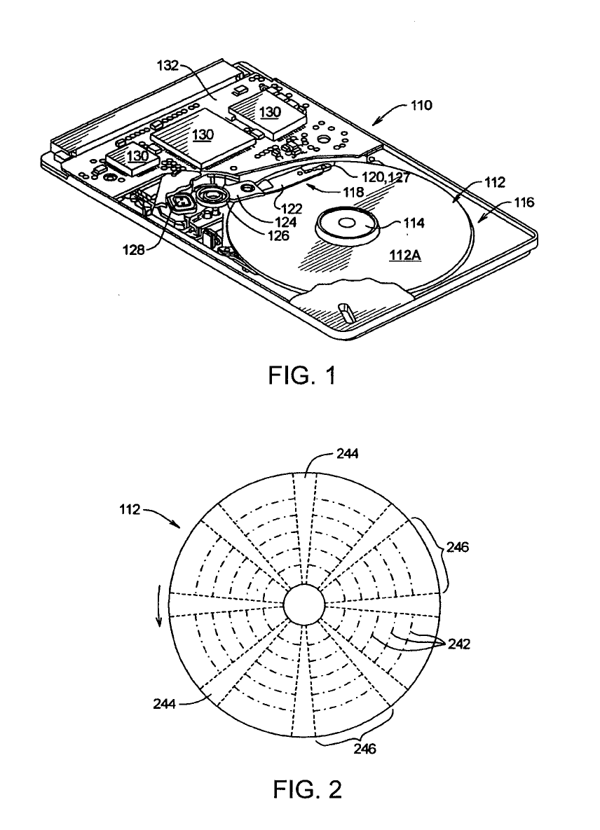

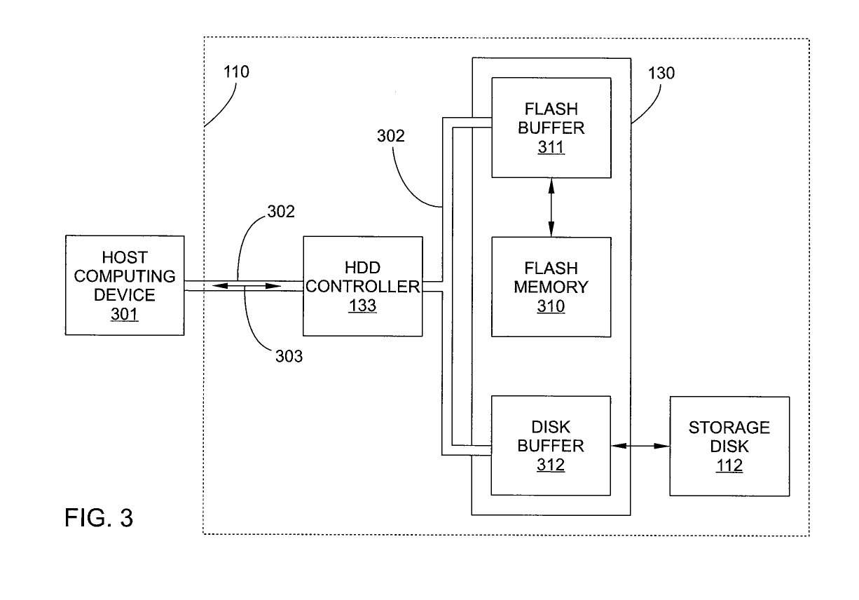

FIG. 1 is a perspective view of an exemplary embodiment of a disk drive 110. For clarity, disk drive 110 is illustrated without a top cover. Disk drive 110 includes at least one storage disk 112 that is rotated by a spindle motor 114. Spindle motor 114 is mounted on a base plate 116. An actuator arm assembly 118 is also mounted on base plate 116, and has a slider 120 mounted on a flexure arm 122 with a read/write head 127. Flexure arm 122 is attached to an actuator arm 124 that rotates about a bearing assembly 126. Voice coil motor 128 moves slider 120 relative to storage disk 112, thereby positioning read/write head 127 over the desired concentric data storage track disposed on the surface 112A of storage disk 112. Spindle motor 114, read/write head 127, and voice coil motor 128 are coupled to electronic circuits 130, which are mounted on a printed circuit board 132. The electronic circuits 130 include a read channel, a microprocessor-based controller, random access memory (RAM), and a flash memory device. Further details of electronic circuits are shown in FIG. 3. For clarity of description, disk drive 110 is illustrated with a single storage disk 112 and actuator arm assembly 118. Disk drive 110 may also include multiple storage disks 112 and multiple actuator arm assemblies 118. In addition, each side of disk 112 may have an associated read/write head 127 coupled a flexure arm 122.

FIG. 2 illustrates storage disk 112 with data organized in a typical manner after servo wedges 244 have been written on storage disk 112 by either a media writer or by disk drive 110 itself via self servo-write (SSW). Storage disk 112 includes concentric data storage tracks 242 located in data sectors 246 for storing data. Concentric data storage tracks 242 are positionally defined by servo information written in servo wedges 244. Substantially radially aligned servo wedges 244 are shown crossing concentric data storage tracks 242 and include servo sectors containing servo information that defines the radial position and track pitch, i.e., spacing, of concentric data storage tracks 242. Such servo information includes a servo sector containing a reference signal that is read by read/write head 127 during read and write operations to position read/write head 127 above a desired track 242. In practice, servo wedges 244 may be somewhat curved, for example, configured in a spiral pattern mirroring the path that would be followed by read/write head 127 if it were to move across the stroke while the disk is not spinning. Such a spiral pattern advantageously results in the wedge-to-wedge timing being independent of the radial position of read/write head 127. Typically, the actual number of concentric data storage tracks 242 and servo wedges 244 included on storage disk 112 is considerably larger than illustrated in FIG. 2. For example, storage disk 112 may include hundreds of thousands of concentric data storage tracks 242 and hundreds of servo wedges 244.

Because disk drive 110 is a hybrid drive, in normal operation data can be stored to and retrieved from storage disk 112 and/or the flash device included in electronic circuits 130. In a hybrid drive, non-volatile memory, such as the flash memory device included in electronic circuits 130, supplements the spinning HDD to provide faster boot, hibernate, resume and other data read-write operations, as well as lower power consumption. Such a hybrid drive configuration is particularly advantageous for battery operated computer systems, such as mobile computers or other mobile computing devices.

When data is transferred to or from disk 112, actuator arm assembly 118 sweeps an arc between an inner diameter (ID) and an outer diameter (OD) of storage disk 112. Actuator arm assembly 118 accelerates in one angular direction when current is passed through the voice coil of voice coil motor 128 and accelerates in an opposite direction when the current is reversed, allowing for control of the position of actuator arm assembly 118 and attached read/write head 127 with respect to storage disk 112. Voice coil motor 128 is coupled with a servo system known in the art that uses positioning data read from storage disk 112 by read/write head 127 to determine the position of read/write head 127 over concentric data storage tracks 242. The servo system determines an appropriate current to drive through the voice coil of voice coil motor 128, and drives said current using a current driver and associated circuitry.

FIG. 3 illustrates a partial block diagram of a host computing device 301 coupled to disk drive 110, according to an embodiment of the invention. Disk drive 110 is connected to host computing device 301 by a system bus 302. As shown, disk drive 110 includes storage disk 112, a disk buffer 312, a flash memory device 310, a flash buffer 311, and an HDD controller 133. Host computing device 301 determines what data is stored on and retrieved from disk drive 110 during normal operation of host computing device 301. Disk buffer 312 is a volatile data buffer, such as a block of dynamic random access memory (DRAM), and serves as a buffer for data being stored on storage disk 112. Flash memory device 310 is a non-volatile solid state storage medium, such as a NAND-flash chip, that can be electrically erased and reprogrammed, and is sized to supplement storage disk 112 in disk drive 110 as a non-volatile storage medium. Flash buffer 311 is a volatile data buffer that serves as a buffer for data being stored on flash memory device 310. Flash buffer 311 may include a block of DRAM. Alternatively, flash buffer 311 may include a block of static random access memory (SRAM), which, unlike a block of DRAM, can advantageously be fabricated as part of the same device or chip as a flash controller chip that serves as the interface between a chip containing HDD controller 133 and a chip containing flash memory device 310. Alternatively, the flash buffer could be a block of SRAM that is fabricated as part of the HDD controller itself. HDD controller 133 controls the operation of disk drive 110, maps the logical block addresses (LBAs) of disk drive 110 to specific physical locations on storage disk 112 and in flash memory device 310, and performs time-multiplexing of system bus 302 according to embodiments of the invention. As shown, HDD controller 133 is configured to split data stream 303 between disk buffer 312 and flash buffer 311 according to embodiments of the invention. In some embodiments, flash buffer 311 and disk buffer 312 are two logical partitions of a single block of DRAM.

System bus 302, also referred to as the “host bus,” is a high-speed bus, such as a serial advanced technology attachment (SATA) bus. System bus 302 is configured with a data transfer rate that is greater than the rate at which data can be written to either flash memory device 310 or storage disk 112. For example, a typical SATA bus for a laptop computer can transfer data at a rate of about 3 gigabits per second (Gbps), which is equal to about 300 megabytes per second (MBs) after accounting for system overhead. In contrast, data can currently be written to a flash memory device at a rate of about 100-200 MBs and to the outer diameter of a 2.5 inch disk at a rate of about 150 MBs. Embodiments of the invention provide systems and methods for transferring a data stream 303 between host computing device 301 and disk drive 110 at an increased data transfer rate by time-multiplexing the data transfer capacity of system bus 302 between storage disk 112 and flash memory device 310. When storage disk 112 and flash memory device 310 retrieve or store data simultaneously as described herein, the effective data transfer rate to disk drive 110 is greatly increased and in some cases nearly doubled. In FIG. 3, system bus 302 is depicted as a single bus, but in some embodiments, system bus 302 may include a first bus between host computing device 301 and HDDcontroller 133 and a second bus connecting HDD controller 133 to flash buffer 311 and disk buffer 312, where the first bus and the second bus have different data transfer speeds. In such embodiments, the data transfer speed of system bus 302 may be considered the slowest of the two buses.

In operation, host computing device 301 transfers data stream 303 to disk drive 110 via system bus 302 and HDD controller 133. Based on a number of factors, HDD controller 133 determines how the data contained in data stream 303 are divided between flash memory device 310 and storage disk 112 so that said data are stored in disk drive 110 at the highest data transfer rate. Factors that can affect how HDD controller 133 divides data between flash memory device 310 and storage disk 112 include the data transfer rate of system bus 302, the sequential data rate of flash memory 310, the sequential data rate of disk drive 112, the data storage capacity of flash buffer 311 and disk buffer 312, and the content of the data being delivered. Thus, when data stream 303 is a relatively large data stream, i.e., larger than flash buffer 311, processor 133 directs alternate portions of data stream 303 to flash memory device 310 and storage disk 112, so that flash memory device 310 and storage disk 112 can each store data simultaneously, thereby increasing the effective sequential data rate of disk drive 110. It is noted that embodiments of the invention are equally applicable to retrieving a data stream from disk drive 110 at an increased effective sequential data rate when portions of the data stream are stored alternately between storage disk 112 and flash memory device 310.

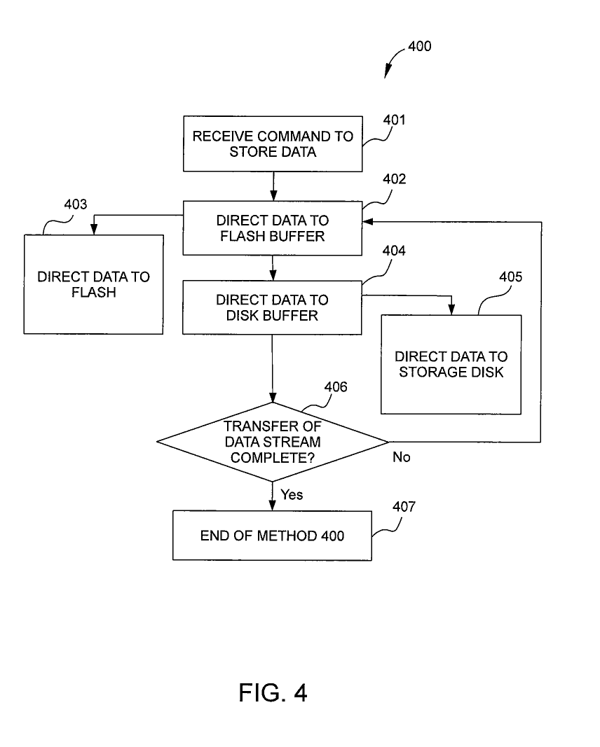

In one embodiment, HDD controller 133 directs data from data stream 303 alternately between flash memory device 310 and storage disk 112 to increase the effective sequential data rate of disk drive 110. This process is illustrated in FIG. 4, which is a flowchart of method steps for writing a data stream alternately to a flash memory device and to storage disk, according to one embodiment of the present invention. Although the method steps are described in conjunction with the system of FIGS. 1-3, persons skilled in the art will understand that any system configured to perform the method steps, in any order, is within the scope of the invention.

As shown, method 400 begins at step 401, where HDD controller 133 receives a command from host computing device 301 to store data stream 303 in a specific block of LBAs (logical block addresses) in disk drive 110. Data stream 303 represents a specific sequential data transfer to disk drive 110, and may be a single large file, such as a hibernate image file, or multiple files that are being stored by host computing device 301 at one time. Because data stream 303 represent one long sequential data transfer between host computing device 301 and disk drive 110, the block of LBAs indicated in the request is generally a block of contiguous LBAs.

In step 402, HDD controller 133 directs a data block FB1 from data stream 303 to flash buffer 311. Data block FB1 is a block of data that makes up a relatively small portion of data stream 303, and may be, for example, about one or two megabytes in size. HDD controller 133 determines the exact size of data block FB1 based on one or more factors described below, such as the data transfer rate of system bus 302, the ratio of the sequential data rate of flash memory 310 to the sequential data rate of disk drive 112, the data storage capacity of flash buffer 311 and disk buffer 312, and/or the content of the data being transferred to disk drive 110. Method 400 proceeds to step 403 shortly after the first data from data block FB1 is received by flash buffer 311. In addition, method 400 proceeds to step 404 when data block FB1 has been completely written to flash buffer 311 in step 402.

In step 403, shortly after the first data from data block FB1 is received by flash buffer 311 in step 402, the transfer of the contents of flash buffer 311 to flash memory device 310 begins. Because the sequential data rate of flash memory device 310 is substantially slower than the data transfer rate of system bus 302, flash buffer 311 continues to fill with the remaining data from data block FB1 even as data is transferred from flash buffer 311 to flash memory device 310.

In step 404, as the contents of flash buffer 311 are being written to flash memory device 310 in step 403, HDD controller 133 directs a data block DB2 from data stream 303 to disk buffer 312. Data block DB2 is a block of data that makes up a relatively small portion of data stream 303, and may be, for example, about one or two megabytes in size. In some embodiments, the size of data block DB2 may not contain the same quantity of data as data block FB1 directed to flash buffer 311 in step 402. HDD controller 133 determines the size of data block DB2 based on one or more of the factors, such as the data transfer rate of system bus 302, the ratio of the sequential data rate of flash memory 310 to the sequential data rate of disk drive 112, the data storage capacity of flash buffer 311 and disk buffer 312, and/or the content of the data being transferred to disk drive 110 and described below. Method 400 proceeds to step 405 shortly after the first data from data block DB2 is received by disk buffer 312 in step 404. In addition, method 400 proceeds to step 406 when data block DB2 has been completely written to disk buffer 312 in step 404.

In step 405, shortly after the first data from data block DB2 is received by disk buffer 312 in step 404, the transfer of the contents of disk buffer 312 to storage disk 112 begins. In embodiments in which a “write-on-arrival” control scheme (described below) is used for writing to storage disk 112, the transfer of the contents of disk buffer 312 to storage disk 112 begins almost immediately after the first data from data block DB2 is received by disk buffer 312. In embodiments in which write-on-arrival is not used, the transfer of the contents of disk buffer 312 to storage disk 112 begins after a short pause, so that read/write head 127 of disk drive 110 can be positioned over the beginning point of the data track on which data block DB2 is to be written. In either embodiment, data is written to storage disk 112 as disk buffer 312 continues to fill with the block of data directed from data stream 303. It is further noted that during step 405, data from data block DB2 is being written to storage disk 112 while data from data block FB1 is concurrently being written to flash memory device 310 in step 403, thereby increasing the effective data transfer rate into disk drive 110.

In step 406, HDD controller 133 determines if the transfer of data stream 303 is complete. If the transfer of data stream 303 is complete, method 400 proceeds to step 407 and ends. If the transfer of data stream 303 is not complete, method 400 proceeds to step 402 as shown, so that steps 402-405 are repeated and data blocks FB3, FB5, etc. are written to flash memory device 310 and data blocks DB4, DB6, etc. are written to storage disk 112. Method 400 continues until data stream 303 has been transferred to disk drive 110.

In some embodiments, the beginning portion of a data block, e.g., data block FB3, is received by flash buffer 311 in step 402 before all of the preceding data block, e.g., data block FB1, has been transferred from flash buffer 311 to flash memory device 310. In this way, data can be continuously written to flash memory device 310 at substantially the maximum sequential data rate of flash memory device 310. Similarly, in some embodiments, the beginning portion of a data block, e.g., data block DB4, is received by disk buffer 312 in step 404 before all of the preceding data block, e.g., data block DB2, has been transferred from disk buffer 312 to storage disk 112. In this way, data can be continuously written to storage disk 112 at substantially the maximum sequential data rate of storage disk 112, since storage disk 112 is never idle and data is continuously written thereto until the transfer of data stream 303 is complete.

Because in method 400 storage disk 112 and flash memory device 310 are able to accept data at or near their respective sequential data rates, the effective sequential data rate of disk drive 110 is substantially increased over prior art hybrid drives, in which a data stream is generally written to either the disk or to the flash memory device. It is noted that while host computing device 301 generally directs disk drive 110 to store data stream 303 in a block of contiguous LBAs, disk drive 110 stores the data of data stream 303 in physically non-contiguous locations, i.e., storage disk 112 and flash memory device 310.

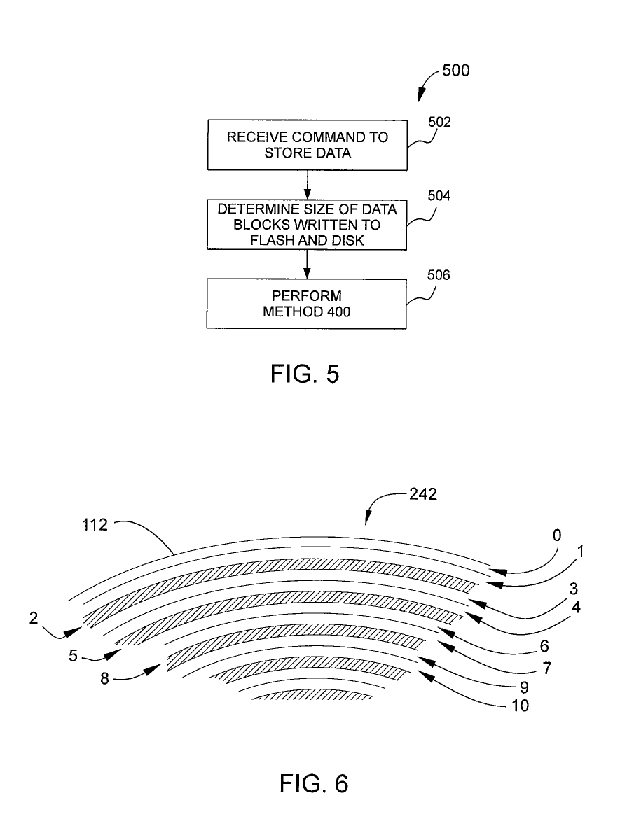

In some embodiments, processor 133 determines the division of data stream 303 between storage disk 112 and flash memory device 310 based on the relative sequential data rates of storage disk 112 and flash memory device 310. Specifically, HDD controller 133 directs proportionally more of data stream 303 to the buffer of the storage medium having the greatest sequential data rate in order to minimize the time that either storage disk 112 or memory device 310 is not storing data from data stream 303. This process is illustrated in FIG. 5, which is a flowchart of method steps for writing a data stream alternately to a flash memory device and to storage disk, according to an embodiment of the present invention. Although the method steps are described in conjunction with the system of FIGS. 1-3, persons skilled in the art will understand that any system configured to perform the method steps, in any order, is within the scope of the invention.

As shown, the method 500 begins at step 502, where HDD controller 133 receives a command from host computing device 301 to store data stream 303 at a specific block of LBAs in disk drive 110.

In step 504, HDD controller 133 determines the size of data blocks stored to flash memory device 310, such as data blocks FB1 and FB3, and the size of data blocks stored to storage disk 112, such as data blocks DB3 and DB4. This determination is based on the relative sequential data rates of storage disk 112 and flash memory device 310. For example, if system bus 302 has a data transfer capacity of 300 MBs, flash memory device 310 has a sequential data rate of 200 MBs, and storage disk 112 has a sequential data rate of 100 MBs, HDD controller 133 will direct twice as much of data stream 303 to flash buffer 311 than to disk buffer 312, i.e., 200 MBs vs. 100 MBs. It is noted that the sequential data rate of storage disk 112 is not constant for all tracks and varies depending on the radial location of the current track to which data is being written. Because the data rate for a particular track is known by HDD controller 133 when a data write is requested by host computing device 301, HDD controller 133 can determine the data rate for any data directed to storage disk 112 and modify the fraction of data stream 303 directed to storage disk 112 accordingly.

In step 506, HDD controller 133 directs data to storage disk 112 and flash memory device 310 as described above in method 400.

Method 500 uses time-multiplexing of the data transfer capacity of system bus 302 as a function of sequential data rates of storage disk 112 and flash memory 310. Such time-multiplexing of system bus 302 allows storage disk 112 and flash memory device 310 to both constantly accept data from data stream 303 at or near their respective maximum sequential data rates, so that the effective sequential data rate of disk drive 110 can be as great as the sequential data rates of storage disk 112 and flash memory device 310 combined. It is noted that if, in the example described above, data stream 303 were instead divided equally between the two storage media of disk drive 110, the effective sequential data rate of disk drive 110 would only be 250 MBs or less: HDD controller 133 would direct 150 MBs to each of storage disk 112 and flash memory device 310, but storage disk 112 could only store 100 MBs and the remaining data would accumulate in disk buffer 312. In addition, if disk buffer 312 fills before the transfer of data stream 303 is completed, further reductions in the effective sequential data rate of disk drive 110 would occur.

In one embodiment, HDD controller 133 determines the division of data stream 303 between storage disk 112 and flash memory device 310 based on the content of data stream 303, and does not randomly split data stream 303 between storage disk 112 and flash memory device 310. For example, when it is known by processor 133 that specific data contained in data stream 303 will be requested while storage disk 112 of disk drive 110 is temporarily unavailable, such data can be intentionally stored on flash memory device 310 to avoid delay caused by waiting for storage disk availability. Thus, the portion of data in a stored data stream that will be first requested by host computing device 301 can be stored in flash memory device 310. For example, when a hibernate state is initiated by host computing device 301, the portion of the hibernate image file that will first be requested by host computing device 301 when resuming after a hibernate state is known, and can be stored in flash memory device 310. After host computing device 301 has requested a resume function and as storage disk 112 is spinning up in response, this first portion of the hibernate image file can be retrieved immediately from its storage location in flash memory device 133; host computing device 301 does not have to wait for storage disk availability to begin the resume process.

In another embodiment, the initial portion of any relatively large stored data stream is stored in flash memory device 310, so that the host does not have to wait for the 20-30 milliseconds generally required for read/write head 127 to seek to the desired portion of storage disk 112. Instead, as read/write head 127 seeks to the desired track, the initial portion of the stored data stream being transferred to host computing device 301 can be retrieved from flash memory drive 133. Thus, in such an embodiment, in addition to a higher effective sequential data rate for disk drive 110, the initial delay that normally occurs when retrieving data from a storage disk can be minimized or eliminated.

In some embodiments, HDD controller 133 determines how data from data stream 303 is divided alternately between storage disk 112 and flash memory device 310 based on the speed at which disk drive 110 can write a complete track of data to storage disk 112. In such embodiments, HDD controller 133 directs sufficient data from data stream 303 to disk buffer 312 for disk drive 110 to write one complete data track to storage disk 112, i.e., one of data storage tracks 242 illustrated in FIG. 2. HDD controller 133 then directs data from data stream 303 to flash buffer 311 until such time that the data directed to flash buffer 311 would occupy an integer number, i.e. a non-fractional number, of complete data storage tracks 242. HDD controller 133 then directs sufficient data from data stream 303 to disk buffer 312 for disk drive 110 to write another complete track and so on. This process continues until all of data stream 303 has been transferred from host computing device 301 to storage disk 112 and flash memory device 310.

In an embodiment in which HDD controller 133 alternately directs one data track of data to storage disk 112 and an integer number of tracks of data to flash memory device 310, the portion of data stream 303 written to storage disk 112 does not form a block of consecutive data storage tracks 242 on storage disk 112. Instead, the portion of data stream 303 that is written to storage disk 112 is arranged as if all of data stream 303 had been written to storage disk 112. Thus, storage disk 112 will include data storage tracks 242 that are completely filled with data from data stream 303 and separated by one or more data storage tracks 242 with no data from data stream 303 written thereon. The data from data stream 303 stored in flash memory device 310 has a size that is less than or equal to the storage capacity of the data tracks with no data written thereon and disposed between the data storage tracks 242 that are completely filled with data from data stream 303.

FIG. 6 illustrates a partial schematic diagram of storage disk 112 with empty data storage tracks alternated with completely written data tracks, according to an embodiment of the invention. Data storage tracks 242 include tracks 0-10, some of which have been completely over-written with data from data stream 303 (denoted by cross-hatching), and some of which have been left completely free of data from data stream 303. As shown, tracks 2, 5, and 8 have been over-written with data from data stream 303 and tracks 0 and 1, 3 and 4, 6 and 7, and 9 and 10 have been left free of data from data stream 303. The data from data stream 303 that would fill tracks 0 and 1, 3 and 4, 6 and 7, and 9 and 10 have been stored in flash memory device 310.

In the embodiment illustrated in FIG. 6, two track's of data have been stored in flash memory device 310 for every track of data written to storage disk 112. Such a configuration occurs when flash memory device 310 has a sequential data rate that is at least twice the sequential data rate of storage disk 112, since flash memory device 310 can then store two track's of data at the same time that one track is written to storage disk 112. One of skill in the art will appreciate that in an embodiment in which the data rate of flash memory device 310 and storage disk 112 are substantially equal, every other track of storage disk 112 is a fully written track. Alternatively, in an embodiment in which the data rate of flash memory device 310 is at least three time the sequential data rate of storage disk 112, each fully written track of storage disk 112 is separated by three empty tracks.

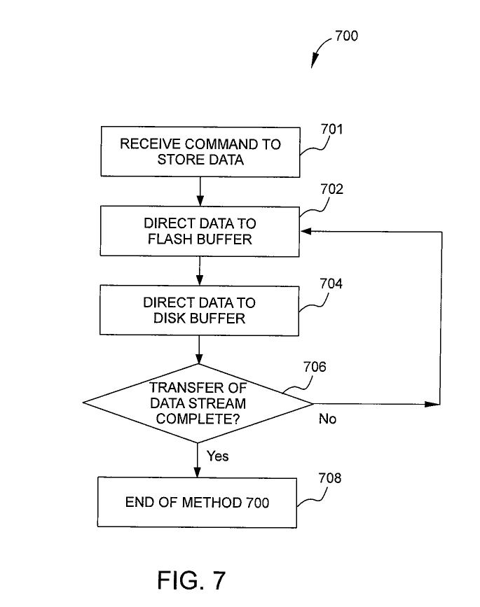

FIG. 7 is a flowchart of method steps for writing a data stream alternately to a flash memory device and to a magnetic storage disk, on which empty data storage tracks are alternated with completely written data tracks, according to one embodiment of the present invention. Although the method steps are described in conjunction with the system of FIGS. 1-3, persons skilled in the art will understand that any system configured to perform the method steps, in any order, is within the scope of the invention.

As shown, the method 700 begins at step 701, where HDD controller 133 receives a command from host computing device 301 to store data stream 303 in a specific block of LBAs (logical block addresses) in disk drive 110.

In step 702, HDD controller 133 directs data block FB1 from data stream 303 to flash buffer 311. Data block FB1 is a block of data that includes the data from data stream 303 to be stored in the LBAs corresponding to tracks 0 and 1 in FIG. 6. As soon as data from data block FB1 is received by flash buffer 311, the transfer of the contents of flash buffer 311 to flash memory device 310 begins. When data block FB1 has been completely written to flash buffer 311, method 700 proceeds to step 704.

In step 704, as the contents of flash buffer 311 are written to flash memory device 310, HDD controller 133 directs data block DB2 from data stream 303 to disk buffer 312. Data block DB2 is a block of data that includes the data from data stream 303 to be stored on track 2 in FIG. 6. In the embodiment illustrated in FIG. 6, data block DB2 includes half as much data from data stream 303 as that included in FB1, since data can be transferred to flash memory device 310 at twice the data transfer data rate that data can be transferred to storage disk 112. As soon as the first data from data block DB2 is received by disk buffer 312, the transfer of the contents of disk buffer 312 to storage disk 112 begins. When data block DB2 has been completely written to disk buffer 312, method 700 proceeds to step 706.

In step 706, HDD controller 133 determines whether the transfer of data stream 303 is complete. If the transfer of data stream 303 is complete, method 700 proceeds to step 708 and ends. If the transfer of data stream 303 is not complete, method 700 proceeds back to step 702, so that step 702 is repeated for data blocks FB3, FB5, etc., and step 704 is repeated for data blocks DB4, DB6, etc., until data stream 303 has been transferred to disk drive 110.

As shown in FIG. 6, upon completion of method 700, only a portion of the data making up data stream 303 is stored on storage disk 112, and the remainder portion of data stream 303 is stored in flash memory device 310. It is noted that the portion of data from data stream 303 stored on storage disk 112, i.e., data blocks DB2, DB4, etc. is written as complete, non-fractional tracks of storage disk 112, i.e., tracks 2, 5, 8, etc. In addition, the remainder portion of data stream 303 that is stored in flash memory device 310, i.e., data blocks FB1, FB3, FB5, etc., has a size that is less than or equal to the storage capacity of empty tracks remaining on storage disk 112, i.e., tracks 0 and 1, 3 and 4, 6 and 7, etc.

An advantage gained by writing only complete tracks of data to storage disk 112 that are separated by unwritten tracks sized to store the data stored in flash memory device 310 is that the data stored on storage disk 112 can be organized as though all of data stream 303 were written to storage disk 112. Organizing data written to storage disk 112 in this way greatly simplifies the “book-keeping” procedures performed by, such as the mapping of LBAs to physical locations on storage disk 112, etc. An additional advantage is that data can also be read from disk drive 110 at a significantly higher rate when alternating track's of data are stored on flash memory device 310 and storage disk 112. Specifically, the data-carrying capacity of system bus 302 can be time-multiplexed when retrieving data from disk drive 110 in the same way that data stream 303 is stored in disk drive 110 as described above. Yet another advantage is that, if desired, the portion of data stream 303 stored in flash memory device 303 can be later written to the empty tracks of storage disk 112 during a time when disk drive 110 is otherwise idle. In this way, a complete copy of data stream 303 can be located sequentially on storage disk 112, and storage space in flash memory device can be made available for other uses. Alternatively, a complete copy of data stream 303 may be written to flash memory device 310 when disk drive 110 is otherwise idle, or a complete copy of data stream 303 may be written at a convenient time in flash memory device 310 and on storage disk 112.

In some embodiments, the sequential data rate of disk drive 110 can be enhanced when writing complete tracks to storage disk 112 by using a “write-on-arrival” scheme. In such a scheme, disk drive 110 does not wait until read/write head 127 is positioned at the beginning of a desired data storage track 242 to write data, and instead begins writing the appropriate data as soon as read/write head 127 has tracked to the desired track. In this way, data can be written to storage disk 112 at approximately the maximum data rate, since data is constantly written to storage disk 112 and no pauses occur while waiting for read/write head 127 to be positioned at the start of each new track. The only pauses in writing occur during short seeks from one track to another. In order to perform write-on-arrival with optimal benefit, all data for the next track to be written must be available in disk buffer 312, so that whatever portion of the track read/write head 127 lands on, writing to the track can occur immediately.

It is noted that the use of write-on-arrival is especially beneficial in embodiments of the invention described herein, because one or more tracks are skipped when writing data to storage disk 112. If write-on-arrival is not used and data is written to storage disk 112 only when read/write head 127 is positioned at the beginning of a desired track, the delay that occurs each time read/write head 127 moves to a track is further compounded by “track skew”. Track skew is the angular offset between the beginning point on one track and the beginning point on an adjacent track. When one or more tracks are skipped, track skew accumulates, and the delay before data can be written to the next desired track is increased significantly while waiting for read/write head 127 to be positioned over the beginning point of the new track.

In some configurations of disk drive 110, limitations in the size of disk buffer 312 and flash buffer 311 may introduce an additional constraint on the effective sequential data rate of disk drive 110. As noted above, in some embodiments, disk buffer 312 should have a storage capacity sufficient to write data up to about 2 data storage tracks 242, where the data capacity of a single data storage track 242 at the OD of storage disk 112 is on the order of 1 or 2 megabytes. When disk buffer 312 has such storage capacity, write-on-arrival of data to a new data track is ensured since the data intended for writing to the next data track can be stored in disk buffer 312. In such embodiments, disk buffer 312 can be configured as DRAM and can readily have 10 s of megabytes of storage capacity. Flash memory device 310 does not have the write-on-arrival constraint associated with storage disk 112, so flash buffer 311 does not have to be sized with a capacity of at least one to two entire data storage tracks 242. However, to ensure that flash buffer 311 is never emptied and therefore data is continuously transferred to flash memory device 310, there is still a minimum desired storage capacity. For example, in a situation in which the sequential data rate of flash memory device 310 and storage disk 112 are approximately equal, if the data transfer speed of system bus 302 is at least twice the sequential data rate of flash memory device 310, then flash buffer 311 should be sized to have the storage capacity of at least one half of a data storage track 242, e.g., 500 kB, in order for a full track of data, e.g., 1 MB, to be sent to disk buffer 312 from system bus 302 at the full speed of system bus 302 before the flash buffer becomes empty. One of skill in the art, upon reading the disclosure herein, can readily size flash buffer 311 appropriately based on the sequential data rate of flash memory device 310 and the data transfer rate of system bus 302 to allow data from data stream 303 to be stored at the full speed of system bus 302.

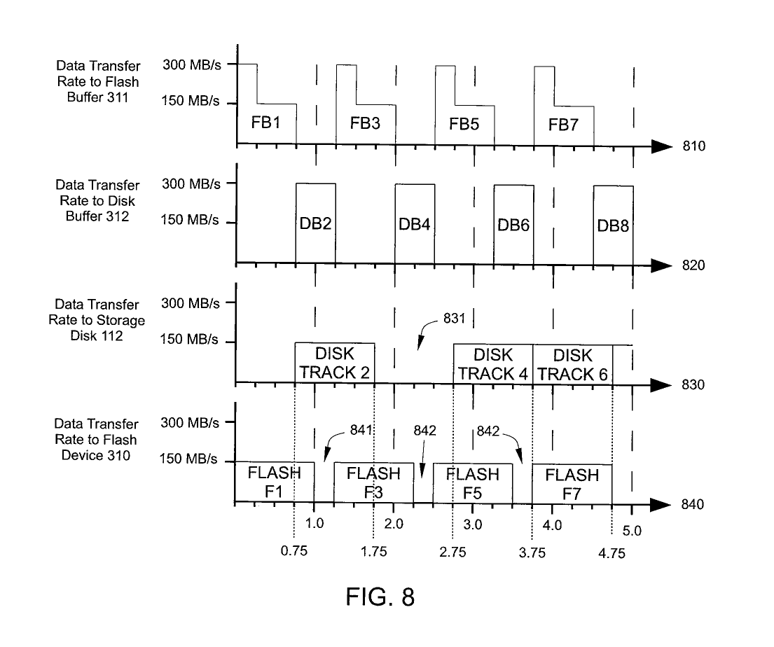

In some embodiments, flash buffer 311 may be an SRAM structure, and consequently may have a data capacity significantly less than that required to ensure that data can be transferred to flash buffer 311 from system bus 302 at the full speed of system bus 302. For example, flash buffer 311 may only have a capacity equivalent to about one quarter of a data storage track 242. In such an embodiment, data will not be transferred continuously to both flash memory device 310 and storage disk 112 because flash buffer 311 will quickly fill and data from system bus 302 will “stall”, since it can only be transferred to flash buffer 311 at the sequential data rate of flash memory 310. In such an embodiment, the data-carrying capacity of system bus 302 is not as easily multiplexed; if flash buffer 311 is undersized, there will be periods when data is not being written simultaneously to flash memory 310 and storage disk 112 due to the “stall” that occurs when system bus 302 writes to flash buffer 311. Consequently, the effective data transfer rate to disk drive 110 will be less than the sum of the sequential data rate of flash memory 310 and the sequential data rate of disk drive 112. However, in such an embodiment, the majority of the time that data stream 303 is transferred to disk drive 110, data is being written simultaneously to both flash memory 310 and storage disk 112, thereby significantly increasing the effective data transfer rate to disk drive 110. Data transfers in such a scenario to flash buffer 311, disk buffer 312, flash memory device 310, and storage disk 112 are illustrated in FIG. 8.

FIG. 8 is a time line diagram illustrating transfer of data to flash memory device 310 and storage disk 112 when flash buffer 311 is too small to allow data to be continuously written to flash memory device 310 at the full speed of system bus 302, according to embodiments of the invention. Although data is not transferred continuously to flash memory device 310 and storage disk 112 when flash buffer 311 is too small to contain at least half of the data contained in a data storage track 242, the effective data transfer rate to disk drive 110 is significantly improved, since the data-carrying capacity of system bus 302 is still time-multiplexed to some degree between flash memory 310 and storage disk 112.

FIG. 8 includes four time lines 810-840, in which the abscissa represents time and the ordinate represents data transfer rate, and the area of each of data blocks FB1, FB3, FB5, FB7, DB2, DB4, and DB6, and DB8 represents a quantity of data. Time line 810 depicts the data transfer from system bus 302 to flash buffer 311 of data blocks FB1, FB3, FB5, and FB7; time line 820 depicts the data transfer from system bus 302 to disk buffer 312 of data blocks DB2, DB4, DB6, and DB8; time line 830 depicts the data transfer of data blocks DB2, DB4, DB6, and DB8 from disk buffer 312 to disk tracks 2, 4, 6, and 8 on storage disk 112; and time line 840 depicts the data transfer of data blocks FB1, FB3, FB5, and FB7 from flash buffer 311 to regions of flash memory device 310, i.e., flash regions F1, F3, F5, and F7, where flash regions 1, 3, 5, and 7 correspond to empty disk tracks (not shown), of storage disk 112.

By way of illustration, time lines 810-840 are described in terms of an embodiment of disk drive 110 in which the data transfer rate to flash device 310 is 150 MBs, the data transfer rate to storage disk 112 is 150 MBs, and the data transfer rate of system bus 302 is 300 MBs. In addition, data blocks FB1, FB3, FB5, and FB7 and DB2, DB4, DB6, and DB8 are each sized to include sufficient data to completely write to a single data track of storage disk 112. Consequently, every other track of storage disk 112 is completely written with data from data stream 303 and the remaining tracks include no data from data stream 303. In the embodiment illustrated in FIG. 8, flash buffer 311 only has capacity for one-quarter of a data track of storage disk 112. One time unit in FIG. 8 represents the time required for one data block, e.g., DB2, DB4, DB6, to be written to storage disk 112. Because in this illustrative example the data transfer rate to storage disk 112 is equal to the data transfer rate to flash memory device 310, one time unit in FIG. 8 also represents the time required for one data block to be transferred to flash memory device 310, e.g., FB1, FB3, or FB5.

As shown in time line 810, flash buffer 311 initially receives the first half of the data making up data block FB1 at 300 MBs, but once flash buffer 311 is filled, can only receive the second half of data block FB1 at the same rate at which data can be transferred from flash buffer 311 to flash memory device 310, i.e., at 150 MBs. Therefore, system bus 302 stalls when flash buffer 311 is filled at time 0.25, and can only transfer data to flash buffer 311 at 150 MBs from time 0.25 to time 0.75. Consequently, system bus 302 cannot begin transferring data block DB2 to disk buffer 312 until time 0.75. As soon as data from data block FB1 is received by flash buffer 311 at time 0.0, data from data block FB1 begins transferring to flash region F1 of flash memory device 310, as illustrated in time line 840.

As shown in time line 820, system bus 302 transfers data block DB2 to disk buffer 312 in 0.5 time units, i.e., from time 0.75 to time 1.25. At time 1.25, system bus 302 is available and begins transferring data block FB3 to the now empty flash buffer 311 (shown in time line 810). Because system bus 302 is not available to transfer data block FB3 to flash buffer 311 at time 1.0, flash buffer 311 remains empty until time 1.25, resulting in pause 841 for 0.25 time units on time line 840, indicating that no data is being written to flash memory device 310 between time 1.0 and time 1.25. Pause 841 on timeline 840 reduces the effective data transfer rate to disk drive 110, since data is not continuously written to flash memory device 310. Additional pauses 842 occur periodically on time line 840, i.e., after each data block is written to flash memory device 310.

Pauses may also occur in writing to storage disk 112, as illustrated in time line 830. By way of illustration, time line 830 depicts the writing of data blocks DB2, DB4, DB6, and DB8 from disk buffer 312 to disk tracks 2, 4, 6, and 8, respectively, on storage disk 112 when write-on-arrival is not used. Because write-on-arrival is not used, data is not always written continuously to storage disk 112; periodically, writing to storage disk 112 is paused until read/write head 127 can be positioned at the beginning of the desired track. One such pause 831, caused by a “missed skew,” is illustrated between the writing of data block DB2 to disk track 2 and the writing of data block DB4 to disk track 4. As shown in time line 830, the read/write head for disk drive 110 is positioned over the beginning point of a track at times 0.75. 1.75, 2.75, 3.75, etc., and at these specific times writing to a new track can begin. However, at time 1.75, when writing of DB2 to disk track 2 has just been completed, data block DB4 has not yet been written to disk buffer 312, and storage disk 112 must make a complete rotation before data block DB4 can be written to disk track 4 at time 2.75. Additional pauses similar to pause 831 will occur periodically, for example prior to data being written to disk track 12 (not shown).

One of skill in the art will appreciate that in an embodiment in which the speed of system bus 302 is twice the steady-state writing speed of flash memory device 310 and flash buffer 311 is large enough to store at least one half the data contained in one of the data blocks written to flash memory device 310, i.e., FB1, FB3, FB5, etc., data can be written to both flash memory device 310 and to storage disk 112 continuously. This is because system bus 302 can transfer a data block to flash buffer 311, e.g., data block FB1, in 0.5 time units and transfer a data block to disk buffer 312, e.g., data block DB2, in 0.5 time units. Thus, in 1.0 time units, system bus 302 can transfer enough data to flash buffer 311 and disk buffer 312 such that data is written continuously to flash memory device 310 and to storage disk 112, and pauses 831 will not be present on time line 830 and pauses 841, 842 will not be present on time line 840. However, in embodiments in which flash buffer 310 is not large enough to allow data to be continuously written to flash memory device 310, as illustrated in FIG. 8, the effective data transfer rate is still increased significantly with respect to conventional data transfer schemes in hybrid drives, in which data is generally transferred to either the storage disk or to the flash memory device. As illustrated by time lines 830 and 840, even with an “undersized” flash buffer, data is being simultaneously written to flash memory device 310 and to storage disk 112 most of the time that data stream 303 is transferred to disk drive 110.

More generally, in order to write data from data stream 303 to flash memory device 310 continuously, and thereby maximizing the effective data transfer rate of disk drive 110, flash buffer 311 should be sized to enable HDD controller 133 to be able to write at least one track of data to disk buffer 312 in the time required to empty flash buffer 310. In other words, flash buffer 311 should be sized to satisfy Equation 1 below:

$$[ \frac{{R}_{SystemBus}}{{R}_{FlashMemory}} ] \times FB = {Data}_{Track} \qquad ( Eqn . 1 )$$

where R_{System Bus}=the data rate of system bus 302; R_{Flash Memory}=the steady-state writing speed of flash memory device 310; FB=the data storage capacity of flash buffer 311; and Data_{Track}=the amount of data contained on one track of the disk at the point where disk-writing will occur.

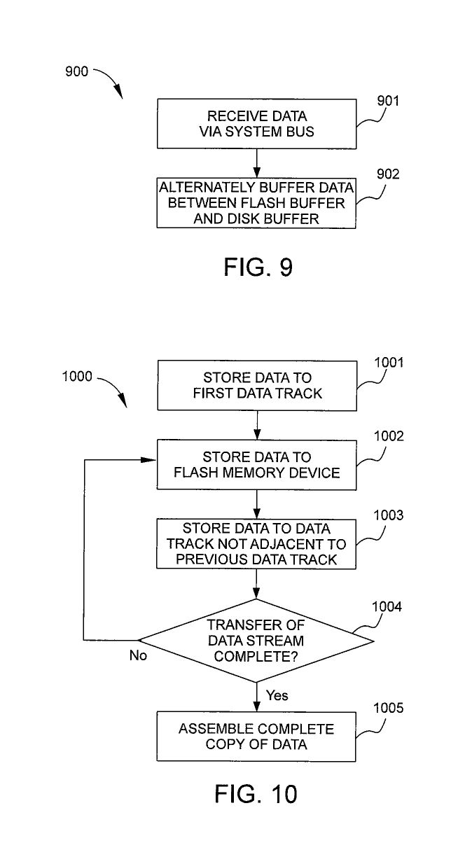

FIG. 9 is a flowchart of method steps for storing a quantity of data in a hybrid data storage apparatus that includes a magnetic storage device and a flash memory device, according to one embodiment of the present invention. Although the method steps are described in conjunction with the system of FIGS. 1-3, persons skilled in the art will understand that any system configured to perform the method steps, in any order, is within the scope of the invention. While method 900 is described in terms of writing a data stream to a hybrid disk drive, one of skill in the art will appreciate that in some embodiments, a similar scheme may be used to read data from the hybrid disk drive at an increased data transfer rate, provided the data has been stored in a suitable fashion, i.e., divided between a storage disk and a flash memory device.

As shown, the method 900 begins at step 901, where HDD controller 133 receives data stream 303 over system bus 302.

In step 902, HDD controller 133 alternately buffers the received data between flash buffer 311 and disk buffer 312. In this way, the data-carrying capacity of system bus 302 is multiplexed between flash buffer 311 and disk buffer 312 so that data from data stream 303 can be stored in flash memory device 310 and storage disk 112 simultaneously.

FIG. 10 is a flowchart of method steps for storing data for a file in a magnetic storage medium with concentric data tracks and a non-volatile solid state storage medium, according to one embodiment of the present invention. Although the method steps are described in conjunction with the system of FIGS. 1-3, persons skilled in the art will understand that any system configured to perform the method steps, in any order, is within the scope of the invention.

As shown, the method 1000 begins at step 1001, where HDD controller 133 stores a first portion of the data from data stream 303 in a first data track of the magnetic storage medium, i.e., storage disk 112.

In step 1002, stores a second portion of the data from data stream 303 in the non-volatile solid state storage medium, i.e., flash memory device 310.

In step 1003, HDD controller 133 stores a third portion of the data from data stream 303 in a second data track of storage disk 112 that is not adjacent to the first data track of the magnetic storage medium. The one or more data tracks of storage disk 112 between the first data track written to in step 1001 and the second data track written to in step 1003 do not contain any portion of the data from data stream 303, but may correspond to the LBAs of data stored in flash memory device 310.

In step 1004, HDD controller 133 determines whether the transfer of data stream 303 is complete. If the transfer of data stream 303 is complete, method 1000 proceeds to step 1005. If the transfer of data stream 303 is not complete, method 1000 proceeds back to step 1002 and repeats steps 1002 and 1003 until data stream 303 has been transferred to disk drive 110. Thus, fourth, sixth, eighth, etc., portions of the data from data stream 303 are stored in flash memory device 310 and third, fifth, seventh, etc., portions of the data from data stream 303 are stored on storage disk 112. In some embodiments, HDD controller 133 uses a write-on-arrival scheme to write data to storage disk 112 in order to realize as nearly as possible the maximum sequential data rate for writing to storage disk 112.

In step 1005, HDD controller 133 consolidates data stored in flash memory device 310 and on storage disk 112 into a complete copy of data stream 303. The complete copy of data stream 303 so formed may be assembled on storage disk 112 or in flash memory 310, or a complete copy may be assembled on both. The consolidation process of step 1005 may take place while disk drive 110 is otherwise idle.

While embodiments of the invention are described herein in terms of writing a data stream to a hybrid disk drive, one of skill in the art will appreciate that in some embodiments, a system bus may be advantageously time-multiplexed for other operations without exceeding the scope of the invention. Specifically, in some embodiments, during a file-copy operation, a host computing device may read from a magnetic storage medium in a hybrid disk drive while writing to a flash memory device in the hybrid disk drive. In other embodiments, time-multiplexing of a system bus can be used to enable faster flush-cache operations by using a flash memory device in a hybrid disk.

In sum, embodiments of the invention provide systems and method for transferring a data stream between a host and a hybrid HDD. By time-multiplexing the data-carrying capacity of a system bus, data can be stored simultaneously on a storage disk and in a flash memory device in the HDD. Consequently, the effective rate of data transfer to and from the hybrid HDD is advantageously increased.

While the foregoing is directed to embodiments of the present invention, other and further embodiments of the invention may be devised without departing from the basic scope thereof, and the scope thereof is determined by the claims that follow.

I claim:

1. In a hybrid data storage apparatus including a magnetic storage device and a flash memory device, a method of storing a quantity of data in the hybrid data storage apparatus, the method comprising the steps of:
receiving data over a bus that connects the hybrid data storage apparatus to a host device; and
alternately buffering the received data between first and second buffers, the first buffer being configured to buffer data for the magnetic storage device and the second buffer being configured to buffer data for the flash memory device.

2. The method of claim 1, further comprising the step of:
simultaneously, storing data buffered in the first buffer in the magnetic storage device and storing data buffered in the second buffer in the flash memory device.

3. The method of claim 2, wherein the step of storing data buffered in the first buffer in the magnetic storage device includes writing data to first and second data tracks of the magnetic storage device that are not adjacent to each other, and wherein a data track of the magnetic storage device between the first and second data tracks does not contain any of the data buffered in the first buffer.

4. The method of claim 3, wherein the step of storing data buffered in the second buffer in the flash memory device includes storing a quantity of data in the flash memory device that is substantially equal to a storage capacity of one or more data tracks of the magnetic storage device between the first and second data tracks.

5. The method of claim 1, wherein the step of alternately buffering the received data between first and second buffers includes the steps of:
(a) buffering the received data into the first buffer;
(b) then buffering the received data into the second buffer; and
(c) then buffering the received data into the first buffer.

6. The method of claim 5, wherein a quantity of the received data buffered into the first buffer during step (a) is at least equal to a storage capacity of a single data track of the magnetic storage device, and a quantity of the received data buffered into the second buffer during step (b) is at least equal to a storage capacity of a single data track of the magnetic storage device.

7. A method of storing data for a file in a magnetic storage medium with concentric data tracks and a non-volatile solid state storage medium, the method comprising the steps of:
storing a first portion of the data for the file in a first data track of the magnetic storage medium;
storing a second portion of the data for the file in the non-volatile solid state storage medium; and
storing a third portion of the data for the file in a second data track of the magnetic storage medium that is not adjacent to the first data track of the magnetic storage medium,
wherein one or more data tracks of the magnetic storage medium between the first data track and the second data track do not contain any portion of the data for the file.

8. The method of claim 7, wherein the one or more data tracks that do not contain any portion of the data for the file comprise at least two data tracks.

9. The method of claim 7, further comprising the steps of:
prior to storing the first portion, buffering data of the first portion in a first buffer; and
prior to storing the second portion, buffering data of the second portion in a second buffer.

10. The method of claim 9, further comprising the step of:
prior to storing the third portion, buffering data of the third portion in the first buffer.

11. The method of claim 10, further comprising the step of:
controlling the buffering so that the second portion is buffered after the first portion and the third portion is buffered after the second portion.

12. The method of claim 9, wherein the steps of storing the first portion of the data for the file in the first data track of the magnetic storage medium and storing the second portion of the data for the file in the non-volatile solid state storage medium occur simultaneously.

13. The method of claim 7, wherein the step of storing the first portion of the data for the file in the first data track of the magnetic storage medium includes writing the first portion of the data for the file to the first data track, said writing being initiated at a point of the first data track other than a beginning point of the first data track.

14. A hybrid data storage apparatus for storing data for a single file across two different storage media, comprising:
a magnetic storage medium with concentric data tracks in which data for a file are stored, wherein each of the data tracks that contain data for the file is adjacent to data tracks that do not contain data for the file; and
a non-volatile solid state storage medium that stores remaining data for the file.

15. The hybrid data storage apparatus of claim 14, further comprising:
a first buffer configured to buffer data for the magnetic storage medium; and
a second buffer configured with at least half of the data storage capacity of a concentric data track disposed at an outer diameter of the magnetic storage medium.

16. The hybrid data storage apparatus of claim 14, wherein two or more data tracks that do not contain data for the file are contiguous and disposed between first and second concentric data tracks in which data for the file are stored.

17. The hybrid data storage apparatus of claim 14, further comprising a controller that is configured to:
receive data for the file over a bus that connects the hybrid data storage apparatus to a host device; and
alternately buffer the received data between first and second buffers, the first buffer being controlled by the controller to buffer data for the magnetic storage medium and the second buffer being controlled by the controller to buffer data for the non-volatile solid state storage medium.

18. The hybrid data storage apparatus of claim 14, wherein the remaining data for the file stored in the non-volatile solid state storage medium has a size that is less than or equal to a storage capacity of the data tracks that do not contain data for the file and are adjacent to data tracks that contain data for the file.

19. The hybrid data storage apparatus of claim 18, wherein the controller is further configured to simultaneously store data for the file to the magnetic storage medium and the remaining data for the file to the non-volatile solid state storage medium.
